(19) United States
(12) Patent Application Publication
(10) Pub. No.: US 2018/0225901 A1
(43) Pub. Date: Aug. 9, 2018

(54) MULTI DOOR REMOTE CONTROL TRANSMITTER

(71) Applicant: DEVANCO CANADA INC., SUMMERSTOWN (CA)

(72) Inventor: DAVID VAN HORNE, ST-URBAIN-PREMIER (CA)

(21) Appl. No.: 15/888,539

(22) Filed: Feb. 5, 2018

Related U.S. Application Data
(60) Provisional application No. 62/454,120, filed on Feb. 3, 2017.

(51) Int. Cl. G07C 9/00

(52) U.S. Cl. CPC G07C 9/00674; G07C 2009/00769; G07C 2009/00928; G07C 9/00857

(57) ABSTRACT

A remote control transmitter (50) for operating two or more a garage door operators, said remote control transmitter (50) including: a plurality of switches (62) that are selectable to provide an address; a microcontroller (60) coupled to said plurality of switches (62) for generating a coded signal in a selected data transmission format, said coded signal including the selected address; a first button (52), second button (54) and third button (56) connectable to the microcontroller (60) for respectively opening, closing and stopping a garage door associated with a corresponding garage door operator; and an encoded switch (58) coupled to said microcontroller (60) for selecting one among the two or more garage door operators. The microcontroller (60) of the transmitter (50) is wirelessly connectable to the corresponding internal on-board radio receiver of the microcontroller of a selected garage door operator.

### FIELD OF THE INVENTION

The present invention relates to remote controller systems including transmitters and/or receivers which operate on a coded signal.

### BACKGROUND OF THE INVENTION

Transmitter-receiver controller systems are used for remote control of garage door openers, gate openers, security systems, and the like. For example, most conventional garage door opener systems use a transmitter-receiver combination to selectively activate a motor, such as an electric motor, for opening or closing the door. The receiver is usually mounted adjacent to the motor and receives an RF coded signal from the transmitter. The transmitter is typically activated by a user to send the coded signal to open or close the garage door.

FIG. 1 illustrates a single garage door operator 10 mounted to the ceiling of a garage and connected to operate a door 17. Garage door operator 10 has a head unit 11 which is supported from the ceiling which includes a motor which drives a suitable chain to which a trolley 13 is attached so that it moves along a rail 12. The trolley 13 has a release cord 20 and pivotally carries a lever arm 14 which is attached to a bracket 16 mounted to the door so as to raise and open it by pulling it along conventional rails. The header unit 11 includes a receiver and operating mechanism and can be actuated from a control unit 38 which has an operate switch 39. The garage door operator can also be operated by a transmitter 26 which has an operate transmit button 27.

As illustrated in FIG. 2 the garage door operator includes a receiver 41 which has a suitable antenna 42 for receiving radio frequency transmissions from the transmitter 26 and supplies an input to a decoder 43 which provides an output to a microprocessor unit 44. The microprocessor unit 44 is connected to a garage door operator mechanism 46 which includes the motor which drives the chain 15 to move the door 17 in a conventional manner. The control unit 38 is connected to the microprocessor 44.

The transmitter 26 has a unique code which is determined by the encoder chip contained in the transmitter that is received by the receiver 41 and decoded by the decoder 43 and supplied to the microprocessor unit 44.

However, when a commercial user needs to operate two or more commercial door operators having open/stop/close functions, then the commercial user may be required to use two or more corresponding transmitters, that is one for each door operator. This is cumbersome for the user, as the user will need to carry several transmitters in order to operate several garage doors.

Furthermore, when a commercial user is required to operate several commercial doors with open/close/stop functions, the user would need to add an external radio receiver and connect the external receiver to the garage door operator.

There is therefore a need for a system that would allow a single commercial transmitter to operate two or more garage door operators for open/stop/close functions without requiring the addition and connection of an external radio receiver on each garage door operator.

### SUMMARY OF THE INVENTION

According to the present invention, there is provided a remote control transmitter for operating two or more a garage door operators, each garage door operator having a microcontroller including an internal on-board radio receiver, said remote control transmitter comprising: a plurality of switches that are selectable to provide an address; a microcontroller coupled to said plurality of switches for generating a coded signal in a selected data transmission format, said coded signal including the selected address; a first button, a second button and third button connectable to the microcontroller for respectively opening, closing and stopping a garage door associated with a corresponding garage door operator; and an encoded switch coupled to said microcontroller for selecting one among the two or more garage door operators. The microcontroller of the transmitter is wirelessly connectable to the corresponding internal on-board radio receiver of the microcontroller of a selected garage door operator.

Other objects and advantages of the present invention will become apparent from a careful reading of the detailed description provided herein, with appropriate reference to the accompanying drawings.

### BRIEF DESCRIPTION OF THE DRAWINGS

Further aspects and advantages of the present invention will become better understood with reference to the description in association with the following Figures, in which similar references used in different Figures denote similar components, wherein:

FIG. 1 is a perspective view of a known garage door operator;

FIG. 2 is a block diagram of a known transmitter-receiver system for the garage door operator of FIG. 1;

FIG. 3 is a front view of a remote control transmitter for a garage door operator, in accordance with an illustrative embodiment of the present invention;

FIG. 4 is a front view of a partially dissembled remote control transmitter for a garage door operator, in accordance with an illustrative embodiment of the present invention;

FIG. 5 is a front view of the partially dissembled remote control transmitter shown in FIG. 4, in accordance with an illustrative embodiment of the present invention;

FIG. 6 is a block diagram of the microcontroller of the remote control transmitter shown in FIG. 5, in accordance with an illustrative embodiment of the present invention; and

FIG. 7 is a block diagram of the microcontroller of the remote control transmitter shown in FIG. 4, in accordance with an illustrative embodiment of the present invention.

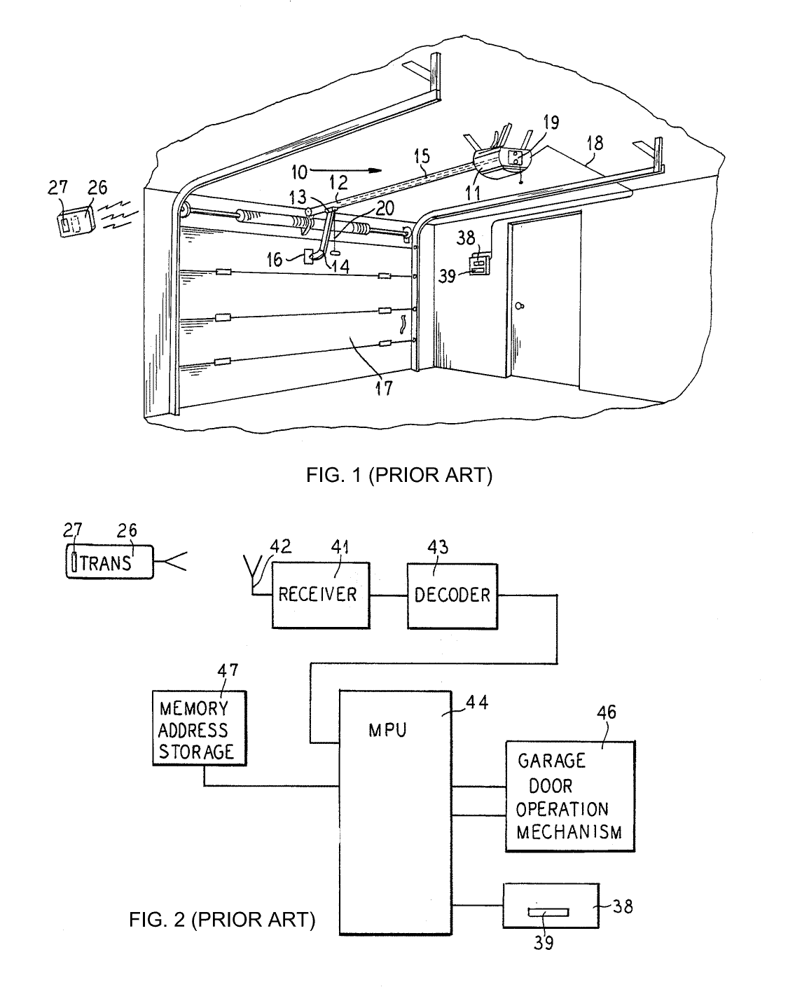

### DETAILED DESCRIPTION OF ILLUSTRATIVE EMBODIMENTS

With reference to the annexed drawings the preferred embodiments of the present invention will be herein described for indicative purpose and by no means as of limitation.

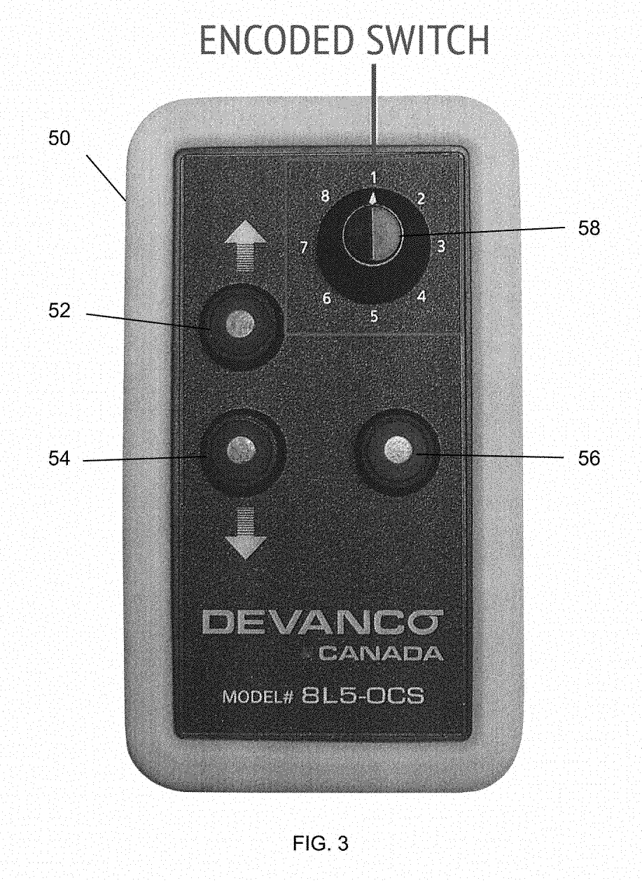

Referring to FIG. 3, there is shown a remote control transmitter 50 for a garage operator, in accordance with an illustrative embodiment of the present invention. The remote control transmitter 50 includes a first button 52 for opening a garage door associated to a garage operator. The remote control transmitter 50 includes a second button 54 for closing the garage door associated to the garage operator. The remote control transmitter 50 includes a third button 56 for stopping the garage door associated to the garage operator. The remote control transmitter 50 includes an encoded rotary switch 58, which may be positioned in eight different positions. In the present example, the remote control transmitter 50 may operate eight different door operators by having a user select one position of the encoded rotary switch 58 among the eight possibilities. People skilled in the art will understand that the encoded rotary switch 58 may have two, three, four, five, six, seven, eight or more positions, corresponding to the number of doors to operate. The rotary switch may be replaced by an encoded electronic switch that the user may control to achieve the same result as the encoded rotary switch 58.

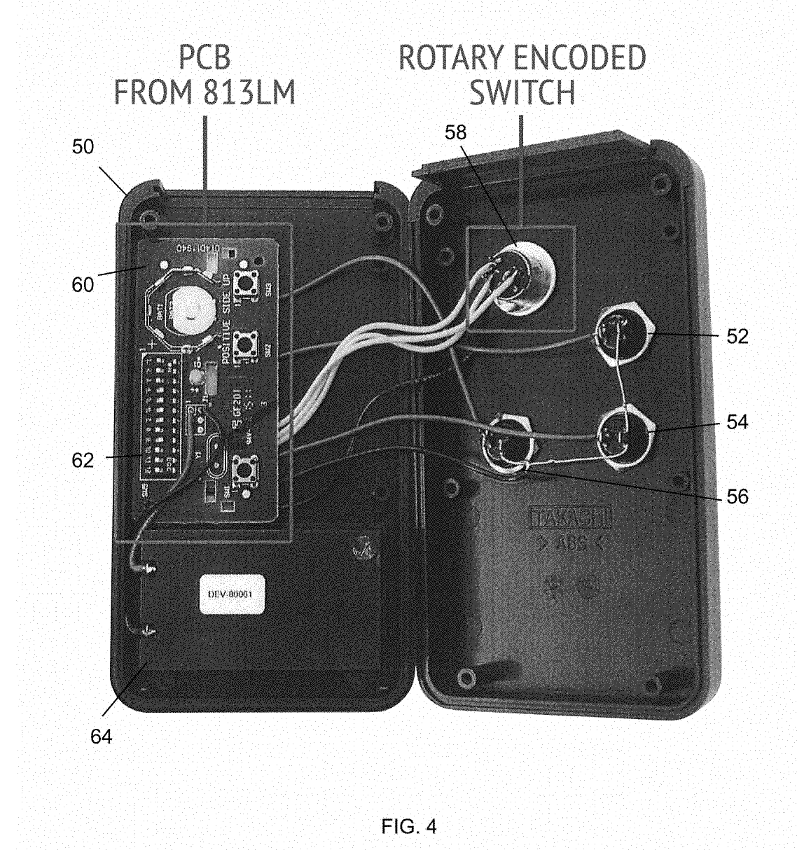

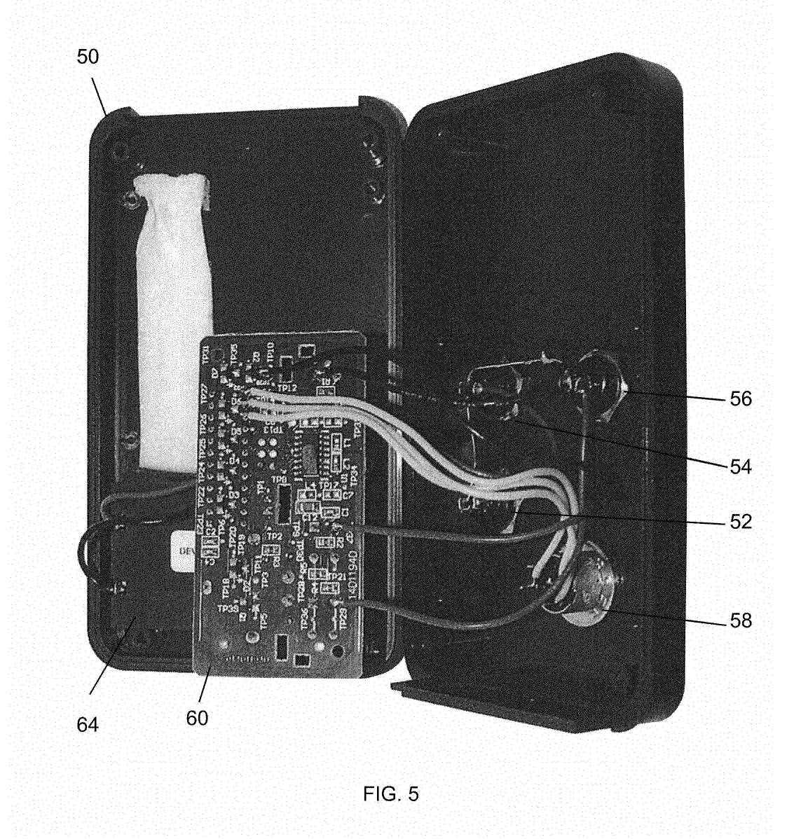

Referring to FIGS. 4 and 5, there is shown the remote control transmitter 50 of FIG. 3 that has been partially disassembled so as to show the inner components thereof.

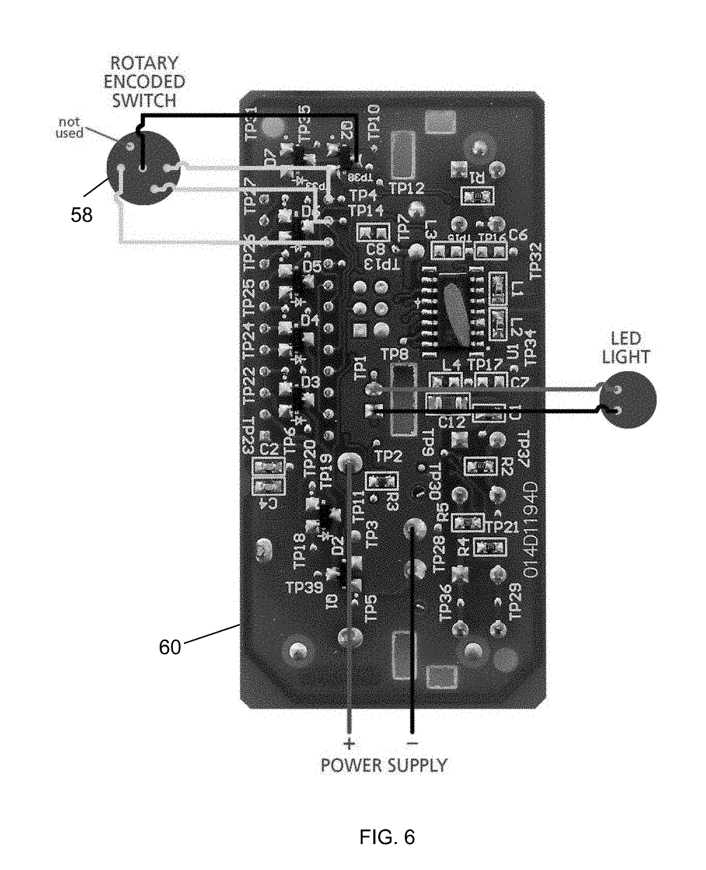

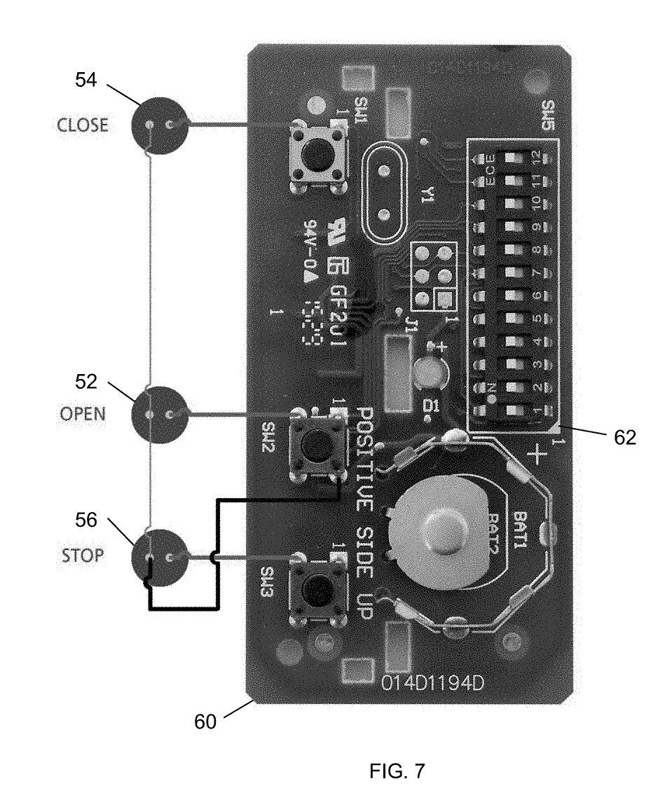

Referring to FIGS. 6 and 7, in addition to FIGS. 4 and 5, the remote control transmitter 50 includes a printed control circuit 60 that is commercially available under the name 813LM by LiftMaster™. The printed control board or microcontroller 60 is used for cooperating with any compatible remote control radio receiver and includes twelve dip switches 62. The twelve dip switches 62 are used for programming the remote control transmitter 50 and allow for a total of 4096 code combinations. The printed control board or microcontroller 60 is connected and powered by a battery 64. The printed control board or microcontroller 60 is also connected to the buttons 52, 54, 56 for respectively opening, closing and stopping the garage door associated with the garage door operator. The encoded rotary switch 58 is connected to the printed control board or microcontroller 60 via three cables and replaces the coding of the dip switches 62. After connecting the encoded rotary switch 58 to the printed control board or microcontroller 60 there are left 512 possible switch combinations. Eight doors can now be controlled with the separate open, close, stop functions via buttons 52, 54, 56.

The remote control transmitter 50 is compatible with the on-board internal radio receiver of the microcontroller in the LiftMaster Logic 5 commercial door operators, or with any other commercial operator with the use of the 850LM or 860LM radio receivers, enabling open/stop/close on multiple doors. Although in the present example, there are illustrated control for eight doors, people skilled in the art will understand that the concept is applicable for two door operators or more. Also, persons skilled in the art will understand that the rotary switch could be replaced by any other equivalent switch, such as an electronic switch, but which would probably be more expensive.

The microcontroller 60 operates to selectively generate an output signal having one of a plurality of data transmission formats or modes of operation. The code dip switch 62 selects a device code or address for the transmitter 50 and provides appropriate inputs to the microcontroller 60. The output of the microcontroller 50 is typically a serial pulse train containing the data word and any required synchronization or timing pulses.

The remote control transmitter 50 is wirelessly connected and programmed directly to an on-board internal radio receiver of the microcontroller in the commercial door or gate operator. For example, the remote control transmitter 50 with its rotary encoded switch 58 is coupled to and is programmed directly to the on-board radio receiver of the LiftMaster Logic 5 Board Commercial door operator, or gate operator. This is advantageous as known multiple door remote controls require the addition of an external radio receiver in order to enable open/stop/close control of several operators.

The scope of the claims should not be limited by the preferred embodiments set forth in the examples, but should be given the broadest interpretation consistent with the description as a whole.

1. A remote control transmitter (50) for operating two or more a garage door operators, each garage door operator having a microcontroller including an internal on-board radio receiver, said remote control transmitter (50) comprising:
a plurality of switches (62) that are selectable to provide an address;
a microcontroller (60) coupled to said plurality of switches (62) for generating a coded signal in a selected data transmission format, said coded signal including the selected address;
a first button (52), second button (54) and third button (56) connectable to the microcontroller (60) for respectively opening, closing and stopping a garage door associated with a corresponding garage door operator; and
an encoded switch (58) coupled to said microcontroller (60) for selecting one among the two or more garage door operators,
wherein the microcontroller (60) of the transmitter (50) is wirelessly connectable to the corresponding internal on-board radio receiver of the microcontroller of a selected garage door operator.

2. The remote control transmitter (50) of claim 1, wherein the encoded switch (58) is a rotary encoded switch.

3. The remote control transmitter (50) of claim 1, wherein the rotary switch (58) is adapted to control up to eight garage door operators.

4. The remote control transmitter (50) of claim 1, wherein the plurality of switches (62) include dip switches.

5. The remote control transmitter (50) of claim 1, wherein the plurality of switches (62) include up to twelve dip switches.
